(19) United States
(12) Patent Application Publication
(10) Pub. No.: US 2009/0146563 A1
(43) Pub. Date: Jun. 11, 2009

(54) PLASMA DISPLAY PANEL AND DEPOSITION APPARATUS USED IN THE MANUFACTURING THEREOF

(75) Inventor: Toshiyuki Nanto, Miyazaki (JP)

Correspondence Address: MILES & STOCKBRIDGE PC, 1751 PINNACLE DRIVE, SUITE 500, MCLEAN, VA, 22102-3833, US

(73) Assignee: Hitachi Plasma Display Limited

(21) Appl. No.: 12/281,914

(22) PCT Filed: Apr. 28, 2006
(86) PCT No.: PCT/JP2006/308941

§ 371 Date: Dec. 16, 2008

(51) Int. Cl. H01J 61/00; H01J 9/00

(52) U.S. Cl. 313/567; 445/58

(57) ABSTRACT

A plasma display panel has a screen (50) composed of a plurality of cells and a dielectric layer (17) across the entirety of the screen, and each cell includes a discharge space (31) filled with a discharge gas, a pair of electrodes (X, Y) for causing discharge in the discharge space (31), and a dielectric that is part of the dielectric layer (17) and that is interposed between the discharge space (31) and the electrodes (X, Y). The dielectric layer (17) has such a distribution of thickness that the dielectric layer is thinnest at the central portion of the screen and is gradually growing from the central portion of the screen toward the peripheral portions of the screen. The distribution of thickness in the dielectric layer makes the variation in the discharge delay between cells prominent, thereby relaxing the concentration of the discharge current.

### TECHNICAL FIELD

The present invention relates to a plasma display panel having a dielectric layer that covers electrodes, a method for manufacturing the plasma display panel, and a deposition apparatus used in the manufacturing.

### BACKGROUND ART

AC-type plasma display panels, which are useful for displaying color images, have a dielectric layer that covers electrodes. The dielectric layer is interposed between the electrodes and a discharge space, and the dielectric layer is charged with a charge called a “wall charge”. AC-type plasma display panels use a wall voltage generated through the charging of the wall charge in their display.

For display images, an operation for writing data in a line-sequential scanning format (addressing) is performed, whereby the cells to be illuminated among the cells arranged on the screen in a matrix are given a higher wall voltage than the wall voltage of the other cells. After this, an operation for maintaining the illumination (sustain) is performed, in which the wall voltage is used to cause a number of display discharges in accordance with the gradation values of the display data. In general, the sustain is commenced after the addressing has been completed for the entire screen, and thus addressing and sustain are temporally separate.

With display performed by plasma display panels, the discharge current is concentrated in a short amount of time, of approximately 1 μs. For example, in a 1024×1024-pixel color screen (where the number of cells is three times the number of pixels), the peak value of the discharge current reaches an ampere order value. Because an integrated circuit for driving and power source circuit suitable for the peak value of the discharge current are necessary for display, it is desirable for the driving device to have a reduced cost and a lighter weight, and for the peak value of the discharge current to be low.

JP H7-29498A can be given as a related art document related to the reduction of the peak value of the discharge current. JP H7-29498A discloses a panel structure in which the thickness of the dielectric layer gradually increases from one end of the screen toward the other end of the screen. With such a panel structure, the discharge starting voltage for cells where the dielectric layer is thick is higher than the discharge starting voltage for cells where the dielectric layer is thin, leading to variation in the start of discharge in response to voltage being applied. In other words, the concentration of the discharge current is relaxed, broadening the current waveform.

Meanwhile, applying the empirical rule of perception that a decrease in luminosity in the peripheral portions of the screen does not stand out relative to a decrease in luminosity in the central portions of the screen to the reduction of energy consumption has been proposed in the past. JP 2001-57158A discloses a panel structure in which the electrode area, which determines the magnitude of discharge, grows smaller from the center of the screen toward the periphery of the screen. The loss of power due to a decrease in the voltage drops by the amount that the electrode area, which has electrical resistance, is decreased. Although the luminosity does decrease, a slight decrease in luminosity can be tolerated in the peripheral portions of the screen. In addition, JP 2003-345297A discloses a plasma display device that reduces the luminosity in the peripheral portions of the screen by adding signal processing to the display data.

Furthermore, in recent years, Chemical Vapor Deposition (CVD) is garnering attention as a method for forming a dielectric layer instead of thick-film processing, in which low-melting point glass paste is printed and burned. For example, Japanese Patent No. 3481142 discusses the formation of a dielectric layer composed of silicon dioxide or organic silicon oxide through plasma CVD.

PATENT DOCUMENT 1 JP H7-29498A

PATENT DOCUMENT 2 JP 2001-57158A

PATENT DOCUMENT 3 JP 2003-345297A

PATENT DOCUMENT 4 Japanese Patent No. 3481142

### DISCLOSURE OF THE INVENTION

With plasma display panels such as those disclosed in the stated background art, where the dielectric layer increases in thickness from one end of the screen toward the other end of the screen, an unnatural distributed luminosity arises, in which the luminosity decreases from one end of the screen toward the other end of the screen. Furthermore, because the discharge properties of the cells differ significantly between the two ends, the permissible range (margin) of the driving voltage is narrow, and thus it is difficult to realize a stable display.

A first object of the present invention is to provide a plasma display panel in which the peak value of the discharge current is low and variation in luminosity between cells does not stand out. A second object is to provide a method and apparatus for manufacturing suited to the mass production of a plasma display panel that achieves the first object.

A plasma display panel that achieves the stated first object has a screen composed of a plurality of cells and a dielectric layer across the entirety of the screen. Each cell includes a discharge space filled with a discharge gas, a pair of electrodes for causing discharge in the discharge space, and a dielectric that is part of the dielectric layer and that is interposed between the discharge space and the electrodes. The dielectric layer has such a distribution of thickness that the dielectric layer is thinnest at the central portion of the screen and is gradually growing in thickness from the central portion of the screen toward the peripheral portions of the screen.

The discharge starting voltage for cells where the dielectric layer is thick is higher than the discharge starting voltage for cells where the dielectric layer is thin, and therefore with a structure in which the thickness of the dielectric layer differs depending on the position in the screen, the variation in the discharge starting period between cells is much more prominent than as compared to a structure in which the thickness of the dielectric layer is consistent across the entire screen. The variation in the discharge starting period relaxes the concentration of the discharge current. When the same voltage is applied to all cells, cells with a low discharge starting voltage (in other words, cells in the central portions of the screen) emit a stronger discharge than cells with a high discharge starting voltage (in other words, cells in the peripheral portions of the screen), and thus the luminance thereof is high. To put it differently, a distributed luminosity corresponding to the thickness of the dielectric layer arises at the time of display. It is basically desirable for the luminosity to be equal throughout the screen, but because viewers of displays frequently look at the central portion of the screen, a distributed luminosity in which the central portion of the screen has a high luminosity that decreases toward the periphery will not stand out.

A manufacturing method that achieves the stated second object includes a deposition step of forming a dielectric layer by Chemical Vapor Deposition on a substrate on which the electrodes are disposed. The amount of raw material gases supplied is made non-uniform, the least amount of raw material gases being supplied at a region of the substrate corresponding to the central portion of the screen, and the amount of raw material gases that is supplied increasing gradually from the region of the substrate corresponding to the central portion of the screen toward regions of the substrate corresponding to peripheral portions of the screen, during the formation of the dielectric layer. Because the amount of material deposited on the substrate corresponds to the amount of raw material gases supplied, a dielectric layer that has a distributed thickness corresponding to the distribution of the amount of raw material gases supplied is obtained.

### BRIEF DESCRIPTION OF THE DRAWINGS

FIG. 1 is a front view illustrating the overall configuration of a plasma display panel.

FIG. 2 is a diagram illustrating the color array of a typical screen.

FIG. 3 is an exploded perspective view illustrating the cell structure of a typical plasma display panel.

FIG. 4 is a schematic view illustrating a cross-sectional structure of essential elements of a plasma display panel.

FIG. 5 is a schematic diagram of the configuration of a deposition apparatus.

FIG. 6 is a schematic diagram of a gas extrusion surface of a shower in a deposition apparatus.

### BEST MODE FOR CARRYING OUT THE INVENTION

A surface-discharge type plasma display panel in which both of first and second electrodes for achieving display discharge are covered by a dielectric layer is suited to the implementation of the present invention.

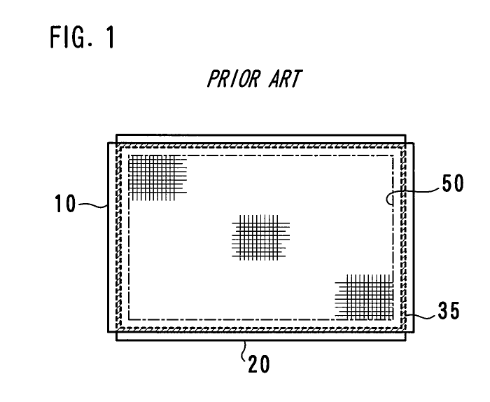

As shown in FIG. 1, the plasma display panel has a front panel 10, a rear panel 20, and a screen 50 configured of cells (light-emitting elements) arranged horizontally and vertically and a discharge gas (not shown). If the screen size is, for example, 42 inches on the diagonal, the plasma display panel is approximately 994 mm by 585 mm. The front panel 10 and the rear panel 20 are members in which multiple layers including electrodes are affixed to an approximately 3 mm-thick glass substrate that is larger than the screen 50. The front panel 10 and the rear panel 20 are arranged opposite each another so as to overlap, and are connected to each another by sealant 35 in a frame shape when viewed from the front disposed in the peripheral portions of the area where the front panel 10 and rear panel 20 overlap with each other. An internal space (discharge space) sealed by the front panel 10, the rear panel 20, and the sealant 35 is filled with the discharge gas.

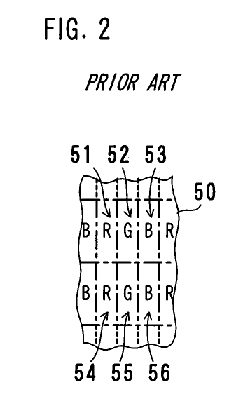

As shown in FIG. 2, the screen 50 is composed of multiple cells arranged in rows and columns. FIG. 2 shows a portion of a row including three cells 51, 52, and 53, and a portion of a row including three cells 54, 55, and 56. The color array in the screen 50 is a striped array in which the light color of cells belonging to each column is the same but the light color of adjacent columns is different. Three cells arranged in the horizontal direction correspond to a single pixel in an image.

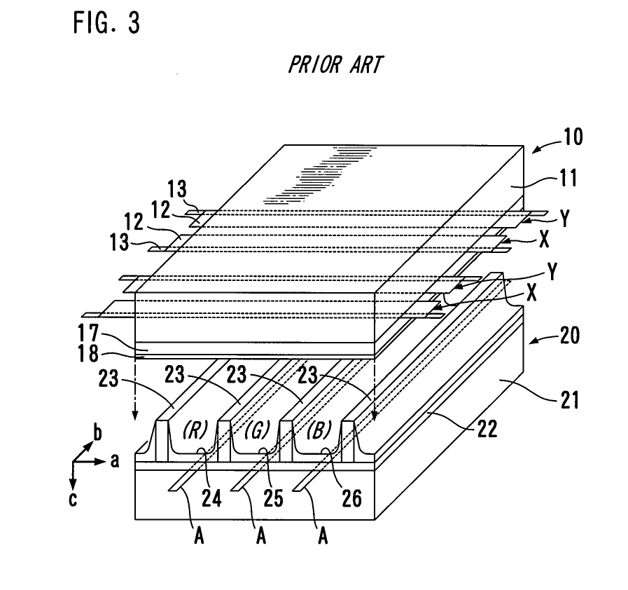

A typical plasma display panel has the surface discharge cell structure shown in FIG. 3. FIG. 3 shows a portion including six cells corresponding to three columns within two rows; the front panel 10 and rear panel 20 are separated from one another to make the internal structure easier to understand.

The front panel 10 includes a glass substrate 11, first row electrodes X, second row electrodes Y, a dielectric layer 17, and a protective film 18. The row electrodes X and row electrodes Y are both laminates of patterned transparent conductive film 12 and metallic film 14. The rear panel 20 includes a glass substrate 21, column electrodes A, a dielectric layer 22, multiple partitions 23, a red (R) fluorescent material 24, a green (G) fluorescent material 25, and a blue (B) fluorescent material 26.

The row electrodes X and row electrodes Y arranged alternately on the inner surface of the glass substrate 11, serving as display electrodes causing surface discharge, are covered by the dielectric layer 17 and the thin protective film 18. The dielectric layer 17 is an essential element in AC-type plasma display panels. Covering the electrodes with the dielectric layer 17 makes it possible to repeatedly cause surface discharge using wall charge accumulated in the dielectric layer 17. The protective film 18 prevents sputtering with respect to the dielectric layer 17.

It should be noted that the arrangement of row electrodes may be either of two well-known forms. One form makes the electrode interval between adjacent rows wider than the electrode interval (surface discharge gap) in each row, as shown in FIG. 3. The other has all the row electrode intervals equal.

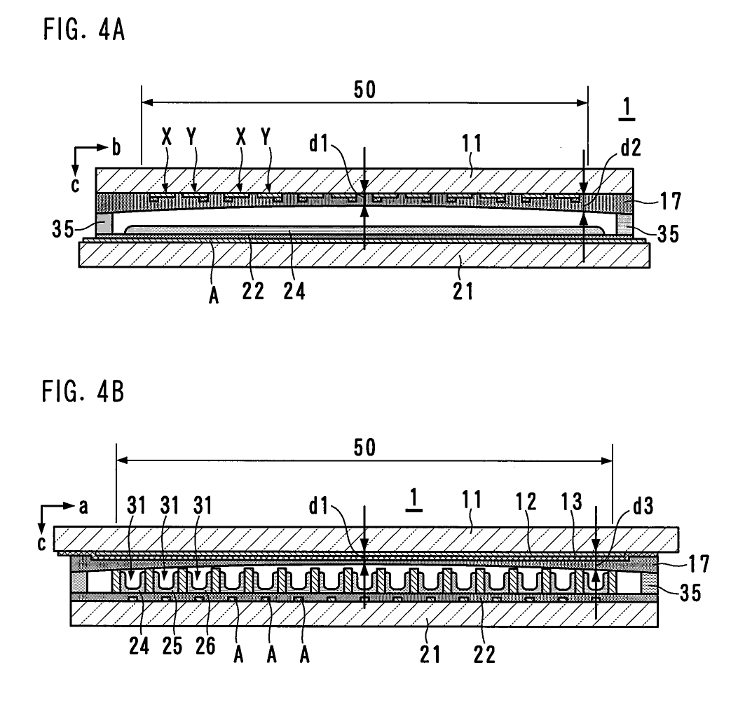

The basic configuration of the plasma display panel 1 shown in FIG. 4 is the same as that shown in FIGS. 1 through 3. To make it easier to understand the structure, the constituent elements of the plasma display panel 1 shown in FIG. 4 are given the same reference numerals in FIGS. 1 to 3. Furthermore, the protective film 18 has been omitted from FIG. 4. FIG. 4 (A) illustrates the structure of a cross-section corresponding to the arrows b and c shown in FIG. 3, whereas FIG. 4 (B) illustrates the structure of a cross-section corresponding to the arrows a and c shown in FIG. 3.

The plasma display panel 1 is provided with the screen 50 composed of multiple cells and the dielectric layer 17 across the entirety of the screen 50. Each cell includes the following: a discharge space 31 filled with a discharge gas; a pair of row electrodes X and Y for causing surface discharge in the discharge space 31; a column electrode A for addressing; and a dielectric that is part of the dielectric layer 17 and that is interposed between the discharge space 31 and the row electrode pair.

In the plasma display panel 1, the dielectric layer 17 has a distributed thickness, being thinnest at the central portion of the screen 50 and growing in thickness from the central portion of the screen toward the peripheral portions of the screen 50. For example, in the case where the size of the screen 50 is 42 inches on the diagonal, the thickness d1 of the dielectric layer 17 in the central portion of the screen 50 is approximately 10 μm, the thickness d2 of the dielectric layer 17 at the ends of the screen 50 in the column direction is approximately 12 μm, and the thickness d3 of the dielectric layer 17 at the ends of the screen 50 in the row direction is approximately 15 μm. In FIG. 4, the difference in thickness is exaggerated.

The CVD method is suited for the formation of the dielectric layer 17, which has such a distributed thickness. Although it is possible, in screen printing of glass paste, to change the printing thickness by adding or removing squeegee pressure, it is extremely difficult to print a film with a thinner center, and thus mass-production through screen printing is unrealistic.

A parallel plate plasma CVD apparatus is suitable for performing deposition onto a comparatively large object such as the glass substrate 11 of the plasma display panel 1.

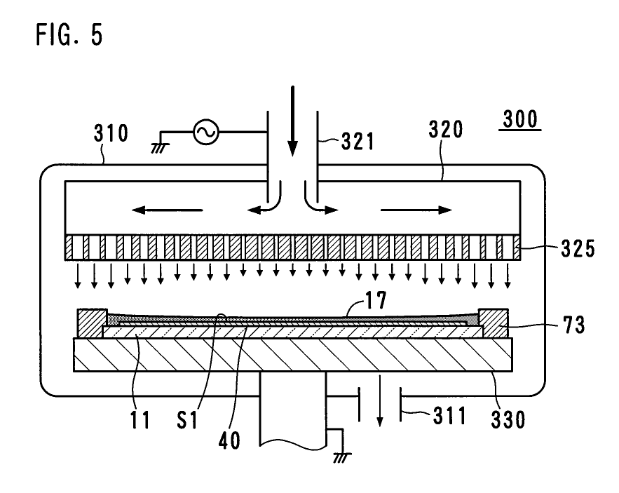

A parallel plate plasma CVD apparatus 300 shown in FIG. 5 includes the following: a chamber (reaction chamber) 310 composed of a metallic receptacle; a shower 320 that disperses raw material gases in a wide range; a mobile base 330 that supports the glass substrate 11, which is the target of the deposition; and a frame 73 that pushes on the glass substrate 11. The shower 320 has a plate 325 in which are formed multiple holes, and this plate 325 doubles as the upper electrode for plasma generation. The bottom surface of the plate 325 is the gas extrusion surface. A heater that applies heat to the glass substrate 11 is incorporated into the mobile base 330, which doubles as the lower electrode.

Within the chamber 310, the glass substrate 11, on which a row electrode group 40 has been formed, is placed between the plate 325 of the shower 320 and the mobile base 330, and plasma is generated in the space between the row electrode group 40 and the plate 325.

The mobile base 330 is a lift-type capable of moving up and down. The mobile base 330 drops when the glass substrate 11 is inserted and removed, coming away from the frame 73, which is fixed. The chamber 310 is provided with an insertion/removal mechanism having an interlock function.

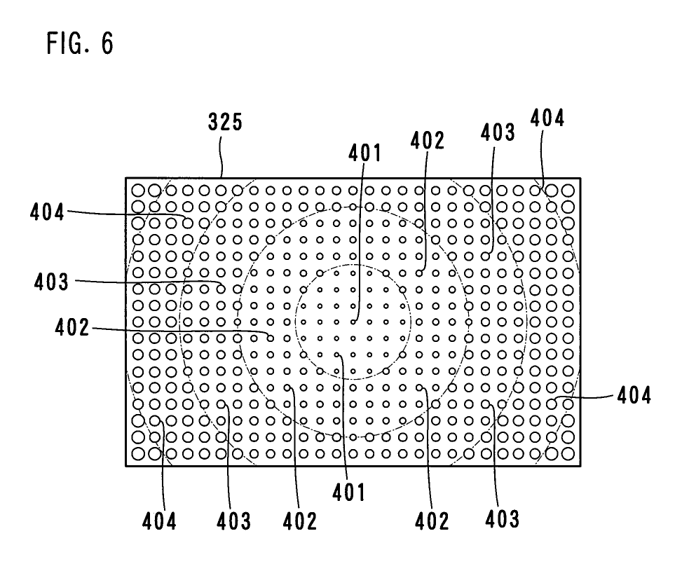

An important characteristic of the plasma CVD apparatus 300 is that the conductance in the porosity of each of the multiple holes in the plate 325 is selected so that the extrusion amount increases from the central portion of the gas extrusion surface toward the peripheral portions of the gas extrusion surface. As shown in FIG. 6, the plate 325 is divided into multiple regions that make up concentric circular border lines around the geometric center of the gas extrusion surface, and the diameter of the holes differs from region to region. The diameter is smallest for holes 401 disposed in a first region that includes the geometric center, and the diameter of holes 402, 403, and 404 in second, third, and fourth regions increases the further away from the geometric center the holes are. In the present example, the pitch at which the holes 401 to 404 are arranged is equal across the entirety of the gas extrusion surface.

An outline of the deposition process shall be described hereinafter.

The pressure inside the chamber 310, into which the glass substrate 11 has been inserted, is decreased to approximately 330 to 470 Pa, and the glass substrate 11 is heated to a temperature of approximately 200 to 400° C.; in this state, the raw material gases are introduced into the chamber 310 via an introduction hole 321 provided in the upper center of the shower 320. For example, when the dielectric layer 17, composed of silicon dioxide (SiO₂), is to be formed, silane (SiH₄) and nitrous oxide (N₂O) are introduced. The introduced raw material gases are extruded over the entirety of the glass substrate 11 via the plate 325. At this time, the extrusion amount is not uniform; rather, as described above, the extrusion amount is smallest at the central portion of the gas extrusion surface and grows larger toward the peripheral portions.

Concomitantly with the introduction of the raw material gases, the chamber 310 is evacuated via a main evacuation hole 311 located below the mobile base 330. The chamber 310 is provided with a vacuum meter (not shown), and the degree of vacuum in the chamber 310 is kept constant by controlling an evacuation valve in accordance with the output of the vacuum meter.

Within the chamber 310, to which are being supplied raw material gases at a constant volume, plasma generated through the application of 1.5 kW to 2.5 kW of high-frequency electricity activates the raw material gases and accelerates a chemical reaction. The film material resulting from the chemical reaction is deposited on a deposition surface S1 on the glass substrate 11, forming the dielectric layer. In the present example, the “deposition layer S1” is the upper surface of the glass substrate 11, on which the row electrode group 40 has been formed.

In such a deposition, the distribution of the thickness of the film depends on the conductance of the plate 325. The more raw material gases are supplied to the plasma generation space between the plate 325 and the glass substrate 11, the more film material is generated from the raw material gases, and thus the greater the deposition rate. Because the conductance of the plate 325 is set so that the amount supplied increases from the center toward the periphery, a dielectric layer 17 with the thickness distribution shown in FIG. 4 is obtained.

In the above embodiment, the method that intentionally makes the amount of raw material gases supplied non-uniform is not limited to a method that uses different diameters for the holes 401 to 404; a method may be used where the density at which the holes for extruding the raw material gases are arranged is changed smoothly or in stages based on the position of the holes in the gas extrusion surface.

The configuration of the plasma display panel 1 can be modified without departing from the spirit of the present invention. Furthermore, the materials, dimensions, and forms of the constituent elements are not intended to be limited to the examples indicated herein. The plasma display panel 1 is not limited to a surface discharge type; an opposed discharge type may be used. The deposition apparatus used in the formation of the dielectric layer 17 is not limited to a parallel plate plasma CVD apparatus. The deposition may be performed using a heat CVD, an optical CVD, or the like.

### INDUSTRIAL APPLICABILITY

The present invention can be used in a display device provided with a surface-discharge type or opposed-discharge type AC-type plasma display panel, and relaxes the demands of current supply capabilities on a driving circuit.

1. A plasma display panel having a screen composed of a plurality of cells and a dielectric layer across the entirety of the screen, each cell including a discharge space filled with a discharge gas, a pair of electrodes for causing discharge in the discharge space, and a dielectric that is part of the dielectric layer and that is interposed between the discharge space and the electrodes,
the dielectric layer having such a distribution of thickness that the dielectric layer is thinnest at the central portion of the screen and is gradually growing in thickness from the central portion of the screen toward the peripheral portions of the screen.

2. A method of manufacturing a plasma display panel having the structure according to claim 1,
wherein the dielectric layer is formed by Chemical Vapor Deposition on a substrate on which the electrodes are disposed,
the amount of raw material gases supplied is made non-uniform,
the least amount of raw material gases being supplied at a region of the substrate corresponding to the central portion of the screen, and
the amount of raw material gases that is supplied increasing gradually from the region of the substrate corresponding to the central portion of the screen toward regions of the substrate corresponding to peripheral portions of the screen, during the formation of the dielectric layer.

3. A deposition apparatus that forms a film by Chemical Vapor Deposition, the apparatus comprising:
a reaction chamber holding a support member for the films;
a shower having a gas extrusion surface in which multiple holes for extruding raw material gases in the reaction chamber are arranged,
conductance of gas flow in the respective holes being determined according to a position at which the respective holes are disposed in the gas extrusion surface, so that the extrusion amount of the raw material gases is lowest at a central portion of the gas extrusion surface and increases from the central portion toward peripheral portions.
